(19) United States
(12) Patent Application Publication
(10) Pub. No.: US 2026/0237212 A1
(43) Pub. Date: Aug. 13, 2026

(54) SYSTEM AND METHOD FOR AI SURVEILLANCE

(71) Applicant: Ravi PRASHER, Vaughan (CA)

(72) Inventor: Ravi PRASHER, Vaughan (CA)

(21) Appl. No.: 19/051,547

(22) Filed: Feb. 12, 2025

(51) Int. Cl. G06V 20/52; G06V 10/764; G06V 40/16; H04W 4/10

(52) U.S. Cl. CPC G06V 20/52; G06V 10/764; G06V 40/172; H04W 4/10

(57) ABSTRACT

The present disclosure relates to a system and method for monitoring a monitored environment. The system detects, from processing first data received from one or more sensors, a first event, the first event being associated with a first action. The system sends, in response to detecting the first event, a first message to a first device, the first device being associated with an actor. The system records a first time in association with the first event. The system determines, from processing second data received from the one or more sensors, that the actor has not initiated performance of the first action within a time frame. The system sends, in response to determining that the actor has not initiated performance of the first action within the time frame, a second message to a second device.

### FIELD

The present disclosure is related to a system and method for artificial intelligence (AI) surveillance. In particular, the present disclosure is related to generating and sending a message in response to detecting an alert condition in a monitored environment and generating a follow-up alert in response to observed or detected developments relating to the detected alert condition.

### BACKGROUND

Hygiene and safety standards, guidelines, and protocols are widely used in environments or industries involved with services, products, or materials that can adversely affect the health of humans. Examples of such environments and industries include without limitation, childcare, healthcare, hospitals, hospitality, hotels, restaurants, cafes, food processing plants, chemical processing plants, and laboratories. Traditional methods of enforcing these standards, guidelines, and protocols often rely on periodic inspections or direct supervisory oversight by a person. These methods may not detect violations of the standards, guidelines, or protocols in real-time. In some situations, a lack of real-time detection of violations of these standards, guidelines, or protocols, may be detrimental. For example, food that has been cross-contaminated with an allergen may be served to a person allergic to the allergen before the cross-contamination has been detected. In another example, surgical tools that have been handled in violation of health and hygiene standards may be used in a surgery prior to detecting the violation. Thus, there is need for a system that detects violations of hygiene and safety protocols and transmits messages or alerts to handlers, operators, or employees in real-time.

### BRIEF DESCRIPTION OF THE DRAWINGS

Reference will now be made, by way of example, to the accompanying drawings which show example embodiments of the present application, and in which:

FIG. 1 is a diagram illustrating an example environment for detecting an alert condition and generating and sending messages relating to the alert condition to an operator device;

FIG. 2 is a block diagram illustrating an example operator device;

FIG. 3 is a block diagram illustrating an example computer system for monitoring a monitored environment, detecting an alert condition in the monitored environment, generating messages relating to the alert condition, and sending messages relating to the alert condition;

FIG. 4 is a simplified diagram illustrating a computer system connected to a plurality of operator devices via a plurality of networks;

FIG. 5 shows, in flowchart form, a simplified method for generating and sending messages relating to a detected alert condition to at least one operator device;

FIG. 6 shows, in flowchart form, a simplified method for identifying a first device, receiving device, or operator device to send a first message to.

FIG. 7 shows, in flowchart form, a simplified method for sending a message relating to a detected alert condition to a second operator device.

Similar reference numerals may have been used in different figures to denote similar components.

### DESCRIPTION OF EXAMPLE EMBODIMENTS

In an aspect, the present disclosure relates to a computer-implemented method, the method comprising: receiving, at a computer system, first data from one or more sensors; processing the first data; detecting, from processing the first data, a first event, the first event being associated with a first action; sending, in response to detecting the first event, a first message to a first device, the first device being associated with an actor; recording a first time in association with the first event; receiving second data from at least one of the one or more sensors; processing the second data; determining, from processing the second data, that the actor has not initiated performance of the first action within a time frame, the time frame being defined by the first time and a predetermined amount of time following the first time; and sending, in response to determining that the actor has not initiated performance of the first action within the time frame, a second message to a second device.

In some implementations, the method further comprises prior to receiving the first data from the one or more sensors, recording, in a storage medium, an association between the first device and the actor. The method further comprises prior to sending the first message to the first device: identifying the actor by processing the first data using at least a facial recognition application; and determining that the fist device is associated with the actor by performing a lookup operation in the storage medium.

In some implementations, the one or more sensors include an image capturing device. The first data includes image data captured by the image capturing device and processing the first data further comprises using computer vision to process the image data.

In some implementations, sending the second message to the second device further comprises: identifying a location associated with the first event; detecting, via at least one wireless connection, one or more devices connected to the computer system, the one or more devices including the second device and not including the first device; determining that, among the one or more devices, the second device satisfies a proximity condition associated with the first event; and sending, in response to determining that the second device satisfies the proximity condition, the second message to the second device.

In some implementations, determining that the second device satisfies the proximity condition comprises using at least one Bluetooth low energy beacon.

In some implementations, determining that the second device satisfies the proximity condition comprises using a Wi-Fi triangulation technique.

In some implementations, the first device is associated with a first status; the second device is associated with a second status, the second status being superior to the first status; and sending the second message to the second device further comprises determining to send the second message to the second device based on the second status being superior to the first status.

In some implementations, the first event relates to a physical threat and the first action is applying a corrective measure to the physical threat.

In some implementations, the method further comprises, prior to sending the first message: selecting, in response to detecting the first event, a first template from one or more templates, the first template being associated with the first event; and generating the first message based on the first template.

In some implementations, the method further comprises generating the first message by passing at least a portion of the first data to a generative artificial intelligence model.

In some implementations, detecting the first event further comprises passing at least a portion of the first data to a generative artificial intelligence model.

In some implementations, the first event relates to at least one of one or more alert conditions, the alert conditions including: poor hygienic practice, improper handing of raw meat, an unhygienic workspace, and improper handling of hazardous materials; the method further comprises training, prior to processing the first data, an artificial intelligence model to detect the at least one of the one or more alert conditions; and processing the first data comprises using the artificial intelligence model to detect the first event.

In some implementations, sending the first message further comprises transmitting the first message to the first device via a push-to-talk network.

In some implementations, the method further comprises recording, in a storage medium and in association with the actor, performance data. The performance data includes at least one of: the detecting of the first event; the first message; the determining that the actor has not initiated performance of the first action within the time frame; and the second message. The method further comprises retrieving, from the storage medium, the performance data; and determining, based on the performance data, a score for the actor.

In another aspect, the present disclosure relates to a computer system comprising a processor and a memory coupled to the processor. The memory stores instructions that, when executed by the processor, cause the processor to: receive first data from one or more sensors; process the first data; detect, from processing the first data, a first event, the first event being associated with a first action; send, in response to detecting the first event, a first message to a first device, the first device being associated with an actor; record a first time in association with the first event; receive second data from at least one of the one or more sensors; process the second data; determine, from processing the second data, that the actor has not initiated performance of the first action within a time frame, the time frame being defined by the first time and a predetermined amount of time following the first time; and send, in response to determining that the actor has not initiated performance of the first action within the time frame, a second message to a second device.

In some implementations, the instructions further configure the processor to, prior to receiving the first data from the one or more sensors, record, in a storage medium, an association between the first device and the actor. The instructions further configure the processor to, prior to sending the first message to the first device: identify the actor by processing the first data using at least a facial recognition application; and determine that the fist device is associated with the actor by performing a lookup operation in the storage medium.

In some implementations, sending the second message to the second device further comprises: identifying a location associated with the first event; detecting, via at least one wireless connection, one or more devices connected to the computer system, the one or more devices including the second device and not including the first device; determining that, among the one or more devices, the second device satisfies a proximity condition associated with the first event; and sending, in response to determining that the second device satisfies the proximity condition, the second message to the second device.

In some implementations, the instructions further configure the processor to generate the first message by passing at least a portion of the first data to a generative artificial intelligence model.

In some implementations, detecting the first event further comprises passing at least a portion of the first data to a generative artificial intelligence model.

In some implementations, the first event relates to at least one of one or more alert conditions, the alert conditions including: poor hygienic practice, improper handing of raw meat, an unhygienic workspace, and improper handling of hazardous materials; the instructions further configure the processor to train, prior to processing the first data, an artificial intelligence model to detect the at least one of the one or more alert conditions; and processing the first data comprises using the artificial intelligence model to detect the first event.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrases “at least one of . . . and . . . ” is intended to cover any one or more of the listed elements, including any one of the listed elements alone, any sub-combination, or all of the elements, without necessarily excluding any additional elements, and without necessarily requiring all of the elements. Similarly, the phrase “at least one of . . . or . . . ” is also intended to cover any one or more of the listed elements, including any one of the listed elements alone, any sub-combination, or all of the elements, without necessarily excluding any additional elements, and without necessarily requiring all of the elements.

The present disclosure relates to an AI surveillance system or, in the alternative, a computer system implementing an AI surveillance system. The system may monitor a monitored environment. In some embodiments, the monitored environment may be an environment related to health and safety. For example, the AI surveillance system may be used in a laboratory that uses or stores radioactive materials or hazardous chemicals. In another example, the AI surveillance system may be used in a hospital or healthcare facility that follows a hygiene or sanitation standard. In another example, the AI surveillance system may be used in a childcare facility that follows a hygiene, health, or sanitation standard. In yet another example, the AI surveillance system may be used in a food-handling facility such as a restaurant kitchen or a food processing plant.

The AI surveillance system may use AI, generative AI, machine learning, and/or computer vision to detect alert conditions. An alert condition may be, for example, a breach of a health guideline, protocol, or standard. For example, in the case of surveillance for a laboratory, an alert condition may correspond to incorrect disposal of toxic waste. In the example of surveillance for a hospital, an alert condition may correspond to incorrect sanitation of surgical equipment. In the example of surveillance for a childcare facility, an alert condition may correspond to providing a spoon that was dipped in peanut butter to a child with peanut allergies. In the example of a restaurant kitchen, an alert condition may correspond to kitchen staff failing to wash hands.

The AI surveillance system may generate messages corresponding to the detected alert conditions. The AI surveillance system may further send or transmit the generated messages to operator devices. Operator devices may be considered devices that are associated with an operator or worker in the monitored environment. For example, in the case of surveillance for a laboratory, the AI surveillance system may send a notification to a device of a laboratory technician wherein the notification instructs the technician to handle incorrectly disposed toxic waste. In the example of surveillance for a hospital, the AI surveillance system may send a notification to a device of a surgeon wherein the notification instructs the surgeon to discard surgical tools or equipment that has been incorrectly sanitized. In the example of surveillance for a childcare facility, the AI surveillance may send a notification to a childcare worker wherein the notification instructs the childcare worker to discard a spoon that is a threat to a child with peanut allergies. In the example of surveillance for a restaurant kitchen, the AI surveillance system may send a notification to a line cook wherein the notification instructs the line cook to wash or rewash their hands.

The AI surveillance may, subsequent to sending a message or notification to an operator or operator device, monitor the monitored environment for a corrective action, or lack thereof. In the event that the AI surveillance does not detect a corrective action or an attempt of a corrective action within a timeframe, the AI surveillance system may send a message or notification to another operator device or second operator device. For example, in the case of surveillance for a laboratory, if the notified technician does not appear to take measures for handling incorrectly disposed toxic waste, the AI surveillance system may send a notification to a second laboratory technician, the second laboratory technician being a next-nearest laboratory technician to the site of the incorrectly disposed toxic waste. Additionally or alternatively, the AI surveillance system may send a notification to a supervisor, manager, or director of the laboratory. Additionally or alternatively, the AI surveillance system may send a notification to all staff, personnel, or technicians associated with the laboratory.

The AI surveillance system may be considered to implement a two-tiered or two-step notification or message process. For example, the AI surveillance system may send a message or first message to a first device or first operator device upon detecting the alert condition. The first message may instruct an operator or holder of the first operator device to handle or correct the alert condition. If the AI surveillance system does not detect a corrective action or attempt at a corrective action with respect to the alert condition, the AI surveillance system may send a second message to a second device or second operator device wherein the second message instructs an operator or holder of the second operator device to handle or correct the alert condition. This two-tiered or two-step notification process may have the technical advantage of saving bandwidth over a network or radio network. For example, employees in a kitchen restaurant may be required to follow food safety protocols. In a first example method, on the one hand, a notification may be sent to each employee upon detection of a food safety protocol breach. In a second example method, a notification may be sent, at first, only to the offending employee. Upon detecting that the offending employee has failed to take action to rectify the breach, a notification may be sent to another employee or all employees. The second example method may heuristically or statistically result in less radio communications than the first example method.

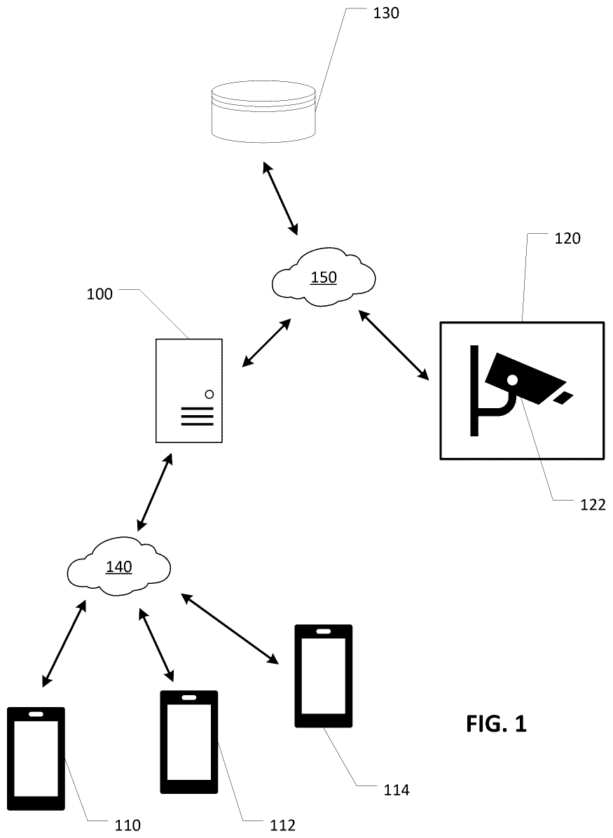

Reference is made to FIG. 1 which illustrates an example computing environment for monitoring a monitored environment, detecting an alert condition in the monitored environment, generating a message relating to the alert condition, and sending the generated message to at least one operator device. In some embodiments, the monitored environment may be a food preparation environment such as a restaurant kitchen or a food processing plant or facility. In some embodiments, the monitored environment may be a facility involved with handling dangerous or hazardous materials such as a biotechnological laboratory, a chemical laboratory, or a nuclear power plant. In some embodiments, the monitored environment may be an environment associated with health guidelines, standards, or protocols such as a healthcare facility, a hospital, or a childcare facility. As shown in FIG. 1, the computing environment may include a computer system 100 (depicted as a server), receiving devices 110, 112, and 114, a monitoring system 120, a database 130, at least one communication network 140 connecting the computer system 100 and the receiving devices 110, 112, and 114, and a wireless network 150 connecting the computer system 100 to the monitoring system 120 and the database 130. The monitoring system 120 may include a sensor system 122 (depicted as a security camera).

The sensor system 122 may include cameras, image capturing devices, video capturing devices, audio recorders, heat sensors, temperatures sensors, moisture sensors, pressure sensors, smoke sensors, air quality sensors, chemical sensors, light sensors, touch sensors, and motion sensors. The sensors of the sensor system may be deployed in, on, or around the monitored environment. The computer system 100 may detect alert conditions or health risk events such as health hazards and safety risks based on data obtained from the sensor system 122. For example, the computer system 100 may detect, based on data received from the cameras of the sensor system 122, that a knife contaminated by peanuts has been used to prepare a bagel sandwich for a person with peanut allergies. In another example, the computer system 100 may detect, based on data received from the heat sensors of the sensor system 122, that the temperature of a room storing temperature-sensitive assets, such as explosives, is approaching a dangerous temperature. The computer system 100 may also manipulate the sensor system 122. For example, in response to detecting the contaminated knife, the computer system 100 may cause the cameras of the sensor system 122 to obtain a better view of the contaminated knife or the person handling the knife (e.g. by zoom functions or tilting the cameras).

The sensor system 122 may also comprise wearable sensors. For example, a laboratory technician may have a camera strapped to their chest, thereby allowing the computer system 100 to collect video data or visual information corresponding to the observations of the laboratory technician. This collected video data or visual information may allow the computer system 100 to determine that the laboratory technician is disposing toxic waste improperly. In another example, kitchen staff may have a camera strapped or otherwise coupled to their chests or foreheads. The computer system 100 may determine from data collected from their chests that the kitchen staff are following food safety guidelines, standards, or protocols correctly.

In some embodiments, the monitoring system 120 may have a monitoring computer system that communicates data from the sensor system 122 to the computer system 100 via the wireless network 150. In other embodiments, the sensor system 122 may communicate directly with the computer system 100 via the wireless network 150. In other embodiments, the monitoring computer system may be or include the computer system 100.

While FIG. 1 depicts the monitoring system 120 as separate from the computer system 100, in some embodiments, the monitoring system 120 may be part of or integrated with the computer system 100. In such embodiments, the sensor system 122 or the sensors therein (such as cameras) may be coupled to the computer system 100. In these embodiments, the network 150 may not connect the computer system 100 to the monitoring system 120.

In some embodiments, the database 130 may store data relating to safety guidelines, standards, or protocols. For example, the database 130 may store data relating to the proper or safe way to dispose hazardous or toxic waste or materials. In another example, the database 130 may store data corresponding to food safety guidelines and protocols. Additionally or alternatively, the database 130 may store a communication history of messages sent and received over the at least one communication network 140. The communication history may include alerts generated by the computer system 100. In some embodiments, the computer system 100 may detect a threat, alert condition, or health risk event by comparing data received from the sensor system 122 with safety guidelines or protocols stored in the database 130. The computer system 100 may use artificial intelligence, generative artificial intelligence, machine learning, video analytics, visual processing, or computer vision to compare the data received from the sensor system 122 with the safety guidelines, standards, or protocols. In some embodiments, the database 130 may be part of the computer system 100. In these embodiments, the wireless network 150 may not connect the computer system 100 to the database 130.

Further, in some embodiments, the database 130 may store records, data records, or profiles relating to actors, operators, staff, or employees. The record, data record, or profile relating to an actor, operator, staff, or employee may include, for example, a device identifier or network identifier for a receiving device, such as one of the receiving devices 110, 112, and 114, that has been paired with or otherwise assigned to the actor, operator, staff, or employee.

The wireless network 150 connects the monitoring system 120, or systems included therein, with the computer system 100 and the database 130. The wireless network 150 may be a cellular network such as a Wi-Fi network, a local area network (LAN), a wide area network (WAN), a 5G network, or a combination thereof.

The at least one communication network 140 may connect the computer system 100 and the receiving devices 110, 112, and 114. The receiving devices 110, 112, and 114 may be any device that supports radio communication including a radio, cellular phone, a smartphone, and a desktop computer. In particular, the receiving devices 110, 112, and 114 may be any device that supports receiving radio communication. Upon detecting a threat, alert condition, or health risk event, the computer system 100 may send an alert to at least one of the receiving devices 110, 112, and 114 over the at least one communication network 140. For example, upon detecting improperly disposed ammonia in a laboratory, the computer system 100 may send an audio alert saying “improperly disposed ammonia detected on Counter 5 of Laboratory 2” to at least one of the receiving devices 110, 112, and 114. In another example, the computer system 100 may send a text alert saying “Improperly disposed ammonia detected on Counter 5 of Laboratory 2.” In another example, upon detecting use of a kitchen knife contaminated with peanuts in preparing a peanut-free bagel sandwich, the computer system 100 may send an audio alert saying “The knife you used has been at least cross-contaminated with peanuts. Please dispose the bagel sandwich you are preparing and use a different knife to prepare the peanut-free bagel sandwich.” Users, operators, or device holders may also use the receiving devices 110, 112, and 114 to send messages to the computer system 100. For example, in response to receiving the message “The knife you used has been at least cross-contaminated with peanuts. Please dispose the bagel sandwich you are preparing and use a different knife to prepare the peanut-free bagel sandwich,” a cook may speak into a mic of the receiving device 110 saying “Understood.” The computer device 100 may also send image or video data to the receiving devices 110, 112, and 114 over the at least one communication network 140. For example, in response to detecting improperly disposed ammonia in a laboratory, the computer system may send an image showing the improperly disposed ammonia to the receiving device 110.

While FIG. 1 illustrates the receiving devices 110, 112, and 114 as handheld devices, in some embodiments, the receiving device 110, 112, or 114 may be a wearable device. For example, the receiving device 110 may be an earpiece or headset worn by kitchen staff.

Further, while FIG. 1 illustrates the receiving devices 110, 112, and 114 using the same icon or representative image, the receiving devices 110, 112, and 114 may be different types of devices. For example, the receiving device 110 may be an earpiece, the receiving device 112 may be a handheld device, and the receiving device 114 may be a desktop computer. Additionally or alternatively, the receiving devices 110 and 112 may be earpieces and the receiving device 114 may be a handheld device.

Further, while FIG. 1 illustrates three receiving devices, namely the receiving devices 110, 112 and 114, in other embodiments, the computing environment may comprise more or less such receiving devices. For example, in some embodiments, the computing environment may comprise two receiving devices. In other embodiments, the computing environment may comprise over a hundred receiving devices.

In some embodiments, the at least one communication network 150 may comprise multiple networks. For example, the communication network 150 may comprise a first network connecting the computer system 100 to the receiving device 110, a second network connecting the computer system 100 to the receiving device 112, a third network connecting the computer system 100 to the receiving device 114, and a fourth network connecting the computer system 100 to all of the receiving devices 110, 112, and 114. In some embodiments, the receiving devices 110 may be held by a first cook in a restaurant kitchen, the receiving device 112 may be held by a second cook in the restaurant cook, and the receiving device 114 may be held by a head chef in the restaurant kitchen. In this embodiment, upon detecting that the first cook has breached a food safety guideline, the computer system 100 may send a message to the receiving device 110. The message may instruct the first cook to rectify or correct the food safety guideline. If the first cook fails to correct or rectify the food safety guideline breach, the computer system 100 may send a second message to the second cook, the head chef, or both. The second message may likewise instruct the second cook or head chef to rectify or correct the food safety guideline breach. In another embodiment, the receiving device 110 may be associated with a first nurse in an operating room, the receiving device 112 may be associated with a second nurse in the operating room, and the receiving device 114 may be associated with a surgeon in the operating room. In this embodiment, upon detecting that the first nurse has breached a sanitary or hygiene protocol for a surgical operation, the computer system 100 may send a message to the receiving device 110. The message may notify the first nurse of the protocol breach. If the first nurse fails to take corrective actions or measures for the breach, the computer system may then send a second message to the second nurse, the surgeon, or both. The second message may likewise notify the second nurse, the surgeon, or both of the protocol breach.

In some embodiments, the receiving devices 110, 112, and 114 may be associated with a status. For example, the receiving devices 110 and 112 may be associated with employees that report to or are supervised by a manager wherein the receiving device 114 is associated with the manager. That is, the receiving device 114 may be associated with a status superior to the status associated with the receiving devices 110 and 112.

While the receiving devices 110, 112, and 114 have been described using the nomenclature “receiving device” as they receive communications from the computer system 100, the receiving devices 110, 112, and 114 may also be considered operator devices since they may be associated with an actor, operator, or staff member in a monitored environment such as a surgeon in a surgery room or a cook in a kitchen.

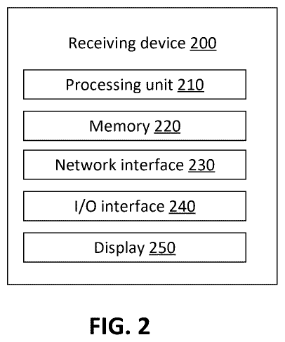

Reference is now made to FIG. 2, which illustrates an example receiving device 200. In some embodiments, the receiving device 200 may be exemplary of the receiving devices 110, 112 and 114 (see FIG. 1). The receiving device 200 may be any electronic device capable of receiving radio communication and emitting sound. Examples of suitable electronic devices include without limitation mobile devices (e.g. smartphones, tablets, laptops, etc.), and wearable devices (e.g. smart watches, smart glasses, ear pieces, smart ear pieces), among others. Example components of the receiving devices 200 are now described, which are not intended to be limiting. It should be understood that there may be different implementations of the receiving device 200.

The receiving device 200 may include at least one processing unit 210 such as a processor, microprocessor, an application-specific integrated circuit (ASIC), a field-programmable gate array (FGPA), a dedicated logic circuitry, a graphics processing unit (GPU), a central processing unit (CPU), a dedicated artificial intelligence processor unit, or combinations thereof. The processing unit 210 may execute communication applications installed on the receiving device 200.

The receiving device 200 may include at least one memory 220, which may include a volatile or non-volatile memory (e.g., a flash memory, a random access memory (RAM), and/or a read-only memory (ROM)). The memory 220 may store instructions for execution by the processing unit 210.

The receiving device 200 includes at least one network interface 230 for wired or wireless communication with an external system or network (e.g., a push-to-talk (PTT) network, cellular, an intranet, the Internet, a P2P network, a WAN, a LAN), and in particular, for communication with a computer system monitoring an environment such as the computer system 100 (see FIG. 1). In some embodiments, the receiving device 200 may be able to wirelessly communicate with the computer system over separate networks. For example, the receiving device 200 may communicate with the computer system 100 over a first communication network and a second communication network. The receiving device 200 may further include a Bluetooth Low Energy (BLE) beacon that allows a computer system such as the computer system 100 (see FIG. 1) to detect the location of the receiving device 200 via a BLE gateway.

In some embodiments, over one of the communication networks connecting the receiving device 200 to the computer system, the receiving device 200 may be a node in a one-way radio communication channel. For example, the receiving device may only receive radio communications or signals transmitted or broadcasted by the computer system. In other embodiments, one of the communication networks connecting the receiving device 200 to the computer system may facilitate two-way radio communication. That is, the receiving device 200 and the compute system may transmit and receive radio communications and/or signals to and from each other. In some embodiments, one of the communication networks connecting the receiving device 200 to the computer system may facilitate PTT communication. In PTT communication, the receiving device 200 may operate in a transmission mode or a reception mode. In transmission mode, the receiving device 200 may transmit or send messages or data to the computer system. In reception mode, the receiving device 200 may only receive messages or data from the computer system. In PTT communication, the receiving device 200 may toggle between transmission mode and reception mode via a switch. In other embodiments relating to PTT communication, the receiving device 200 may be, by default, in reception mode. In these embodiments, the receiving device 200 may be in transmission mode when a trigger is active. The trigger may be active, for example, while a user or operator applies pressure or force to a transmission mode button.

The receiving device 200 may also include at least one input/output (I/O) interface 240, which interfaces with input and output devices. In some examples, the same component may serve as both an input and output device (e.g., a display 250 may be a touch-sensitive display). The receiving device 200 may include other input devices (e.g., buttons, microphone, touchscreen, keyboard, etc.) and other output devices (e.g., speaker, vibration unit, etc.). In some embodiments, the receiving device 200 may only have an output interface and output devices. For example, the receiving device 200 may be an earpiece with a speaker and be the receiving end of a one-way radio communication channel.

The receiving device 200 may also include a display 250. In some embodiments, if a PTT application is running on the receiving device 200, the display 250 may show the words “transmission” when the receiving device 200 is in transmission mode. Likewise, the display 250 may show the words “reception” when the receiving device 200 is in reception mode. In some embodiments, a PTT application running on the receiving device 200 may cause the display 250 to show a switch button. Pressing the switch button may cause the receiving device 200 to switch from reception mode to transmission mode or vice versa. Additionally or alternatively, a PTT application running on the receiving device 200 may cause a PTT button on the display 250 wherein pressing the PTT button causes the receiving device 200 to enter transmission mode whereas the receiving device 200 would otherwise be in a default reception mode.

In other embodiments, a computer system monitoring an environment, such as the computer system 100 (see FIG. 1), may detect an alert condition and send or transmit image data representative of the alert condition to the receiving device 200. The receiving device 200 may display an image rendered from the received image data on the display 250. For example, the computer system may detect, in an operation room of a hospital, a scalpel that has not been sanitized according to appropriate health guidelines, standards, or protocols. The computer system may capture an image of the scalpel and send the message to the receiving device 200. The receiving device 200, or the at least one processing unit 210, may then display the image of the scalpel on the display 250. In this example, the receiving device 200 may be held by a nurse, surgeon, or surgical technologist in the operating room.

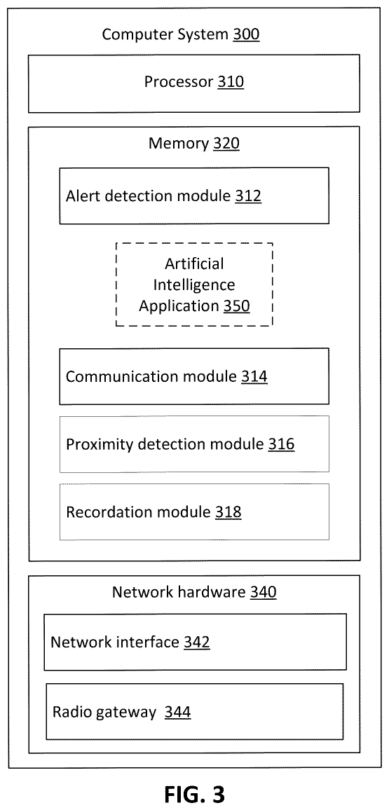

Reference is now made to FIG. 3 which illustrates an example computer system 300 for monitoring an environment, detecting a threat, alert conditions, or health risk event, generating an alert, message, or notification relating to the detected threat, alert condition, or health risk event. The computer system 300 may be exemplary of the computer system 100 (see FIG. 1). As shown in FIG. 3, the computer system 100 may include at least one processor 310 and a memory 320. The at least one processor 310 may be a central processing unit, a microprocessor, a signal processor, an application-specific integrated circuit (ASIC), a field-programmable gate array (FGPA), a dedicated logic circuity, a dedicated artificial intelligence processor unit, a graphic processing unit (GPU), a tensor processing unit (TPU), a neural processing unit (NPU), a hardware accelerator, or combinations thereof. The memory 320 may include volatile or non-volatile memory (e.g. a flash memory, a random access memory, (RAM), and/or a read-only memory (ROM)). The memory 320 may be considered a computer-readable storage medium storing computer-executable instructions or a memory storing computer-executable instructions. The memory 320 may store instructions for execution by the at least one processor 310. The memory 320 may be coupled to the at least one processor 310.

Although FIG. 3 shows a single instance of each component, there may be multiple instances of each component in the computer system 300. Further, although the computer system 300 is illustrated as a single block, the computer system 300 may be a single physical machine or device (e.g. implemented as a single computing device, such as a single workstation, single end user device, single server, etc.), or may comprise a plurality of physical machines or devices (e.g., implemented as a server cluster). For example, the computer system 300 may represent a group of servers or cloud computing platform providing a virtualized pool of computing resources (e.g., a virtual machine, a virtual server).

The memory 320 may contain security software, programming, or computer-executable instructions which, when executed by the processor 310, perform various surveillance and notification functions. In the embodiment illustrated in FIG. 3, the memory 320 stores an alert detection module 312, a communication module 314, a proximity detection module 316, and a recordation module 318.

The alert detection module 312 comprises instructions that allow the processor 310 to detect an alert condition or a health risk event. The processor 310 may detect the alert condition or health risk event by analyzing or processing data obtained from a sensor system such as the sensor system 122 (see FIG. 1). In some embodiments, the processor 310 may analyze or compare the obtained data against one or more guidelines, standards, or protocols. These one or more guidelines, standards, or protocols may be stored in a storage medium such as an internal storage of the computer system 300 or a database such as the database 130 (see FIG. 1). Further, the processor 310 may analyze or process the data in real-time. That is, the processor 310 may detect the alert condition or health risk event in real-time.

Data obtained from the sensor system may include image and video data from cameras, image capturing devices, or video capturing devices, audio data from audio recorders, temperature or heat data from heat sensors or temperature sensors, moisture data from moisture sensors, pressure data from pressure or touch sensors, lighting data from light sensors, chemical data from smoke sensors or other chemical sensors such as air quality sensors, motion data from motion sensors, BLE data from BLE gateways, and RFID data from RFID readers. Temperature or heat data may relate to the temperature or heat of a room or an object. For example, the processor 310 may detect that the internal temperature of a refrigerator in a restaurant is too warm for the refrigerator to adequately function as a refrigerator. That is, the internal temperature of the refrigerator may give rise to a health risk to a restaurant customer who eats food prepared with ingredients that have been stored in the refrigerator.

In some embodiments, the processor 310 may detect a threat, alert condition or health risk event using video analytics or image analysis on video or images received from cameras. For example, the processor 310 may use video analytics or computer vision to detect that a cook in a kitchen is using a contaminated knife or that the cook has insufficiently washed their hands.

In some embodiments, the processor 310 may use a facial recognition application to identify an actor or operator associated with the detected alert condition or health risk event. For example, in addition to detecting that a cook in a kitchen is using a contaminated knife, the processor 310 may identify the cook. Specifically, a facial recognition application may output an identifier (such as an employee ID or name) that corresponds to the cook. The processor 310 may then use the identifier to, for example, store, in a database such as the database 130, data relating to the alert condition or health risk event in a profile of cook. Additionally or alternatively, the processor 310 may perform a lookup operation in the database 130 to identify a receiving device associated with the cook.

In some embodiments, the processor 310 may use at least one artificial intelligence application 350 to detect alert conditions or health risk events. The artificial intelligence application 350 may include a machine learning model, a generative artificial intelligence model, or a computer vision program. In some embodiments, the artificial intelligence application 350 may be stored internally in the computer system 300. In other embodiments, the artificial intelligence application 350 may be stored externally. For example, the artificial intelligence application 350 may be stored in an external server managed by a third party such as a cloud computing service. In some embodiments, the processor 310 may make calls to the artificial intelligence application 350 to detect alert conditions or health risk events. The artificial intelligence application 350 may detect alert conditions or health risk events based on sensor data such as camera footage and a set of guidelines, standards, or protocols.

In some embodiments, the artificial intelligence application 350 may be a machine learning model that has been trained using paired data wherein at least some of the pairs comprise example sensor data and a corresponding breached guideline, standard, or protocol. Additionally or alternatively, training data for the artificial intelligence application 350 may include paired data wherein at least some of the pairs comprise example sensor data and a corresponding indication that the example sensor data shows or represents a “safe situation,” or a situation with no breaches of a set of guidelines, standards, or protocols.

In some embodiments, the artificial intelligence application 350 may output text. Example text may be “Cook A is using a contaminated knife” or “Scalpel A has not been sufficiently sanitized.”

In some embodiments, the at least one artificial intelligence application 350 may include a facial recognition application. Thus, the processor 310 may make a call to the at least one artificial intelligence application 350 to identify an actor or operator associated with an alert condition or health risk event.

The communication module 314 comprises instructions that allow that processor 310 to communicate with actors, operators, staff, or personnel related to the monitored environment. That is, the communication module 314 may comprise instructions allowing the processor 310 to communicate with receiving devices or operator devices such as the receiving device 200 (see FIG. 2). Examples of operators, actors, staff, and personnel include laboratory technicians of a monitored laboratory, medical staff in a hospital or operating room, childcare workers in a childcare facility, and cooks or kitchen staff in a kitchen. In some embodiments, the processor 310 may generate messages or notifications corresponding to the detected alert condition or health risk event. For example, in response to detecting incorrectly disposed ammonia at, for example, a Table 6 in a Laboratory A, the processor 310 may generate the message “Ammonia improperly disposed in Laboratory A at Table 6.” In another example, in response to detecting that a Cook A is using a contaminated knife, the processor 310 may generate the message “Cook A's knife is contaminated. Please send knife for sanitization and use clean knife.”

In some embodiments, the processor 310 may generate messages or notifications based on deterministic algorithms. For example, a message such as “Ammonia improperly disposed in Laboratory A at Table 6” may be generated by following a deterministic algorithm, namely “[chemical] [breach type] in [laboratory ID] at [location in laboratory].”

In some embodiments, the processor 310 may generate messages or notifications using generative artificial intelligence. For example, “Cook A's knife is contaminated” may be generated using generative artificial intelligence. In some embodiments, the processor 310 may make a call to the at least one artificial intelligence application 350 to generate a message or notification. Additionally or alternatively, a message or notification may be generated during the same call to the artificial intelligence application 350 that detected the alert condition or health risk event.

In some embodiments, the processor 310 may generate audio messages. In another embodiment, the processor 310 may generate a text or string message. Further, in some embodiments, the processor 310 may attach video data or image data to the generated message. For example, in the case of a monitored operating room, the processor 310 may attach an image identifying an insufficiently sanitized scalpel to the generated message.

In some embodiments, the communication module 314 may allow the processor 310 to interpret responses received from a receiving device or operator device such as the receiving device 200. For example, after sending the message “Knife is contaminated. Please sent for sanitization” to a receiving device associated with a cook in a kitchen, the computer system 300 may receive the response “understood.” The processor 310 may interpret “Understood” to mean that the cook will send the knife for sanitization.

In some embodiments, the processor 310 may select a particular receiving device from a plurality of receiving devices to send, transmit, or communicate the generated message or notification. For example, the processor 310 may, upon detecting a breach of a standard, guideline, or protocol, determine an actor or operator responsible for the breach. The processor 310 may then select a receiving device associated with the actor or operator and send a message or notification to that receiving device. Additionally or alternatively, the processor 310 may, upon detecting a breach of a standard, guideline, or protocol, determine an actor or operator most suited to handle or rectify the breach. The processor 310 may then select a receiving device associated with the actor or operator and send a message or notification to that receiving device. Further, if the breach is not rectified within a given timeframe, the processor 310 may select another receiving device and send a message or notification to that receiving device.

The proximity detection module 316 comprises instructions allowing the processor 310 to detect or determine proximities or locations of receiving devices. For example, the processor 310, upon detecting an alert condition or health risk event, may determine a closest receiving device to a location associated with the alert condition or health risk event. The processor 310 may then, via execution of instructions in the communication module 314, send a message or notification to the receiving device. In some embodiments, the processor 310 may use video analytics or computer vision, or calls to the at least one artificial intelligence application 350, to determine proximities or locations of the receiving devices. In such embodiments, the processor 310 may, in practice, determine proximities or locations of actors, operators, or staff members associated with the receiving devices. In other embodiments, the processor 310 may use data collected from one or more BLE gateways do determine proximities or locations of the receiving devices. In such embodiments, the receiving devices may comprise BLE beacons that periodically emit signals. In other embodiments, the processor 310 may use data collected from routers to determine proximities or locations of the receiving devices. In yet further embodiments, the processor 310 may use data collected from RFID readers to determine proximities or locations of the receiving devices. In such embodiments, the receiving devices may have active RFID tags that periodically or continuously emit RFID signals.

The recordation module 318 comprises instructions allowing the processor 310 to record or log data relating to alert conditions, health risk events, or messages or notifications generated and received in relation to alert conditions or health risk events to a database such as the database 130 (see FIG. 1). Data recorded to the database may include without limitation a type or description of the detected alert condition or health risk event, the message or notification generated in response thereto, a response time to rectify or remedy the alert condition or health risk event, a cause of the alert condition or health risk event, an identifier for an actor or operator responsible for the alert condition or health risk event, and an identifier for an actor or operator that rectified or remedied the alert condition or health risk event. The data recorded to the database may be analyzed, by a person, a computer, or a combination thereof, at a later time to identify, for example, measures that can be taken to reduce the likelihood of an occurrence of an alert condition or health risk event.

FIG. 3 shows the computer system 100 including network hardware 340. The network hardware includes at least one network interface 342 and at least one radio gateway 344. The network hardware facilitates wires or wireless communication with an external system or network(e.g., a PTT network, cellular, an intranet, the Internet, a P2P network, a WAN, a LAN), and in particular, facilitates communication with a receiving device such as the receiving device 200 (see FIG. 2) and communication with a monitoring system such as the monitoring system 120 (see FIG. 1). In some embodiments, the computer system 300 may be able to wirelessly communicate with a receiving device over a communication network such as the communication network 140 (see FIG. 1). In some embodiments, the computer system 300 may engage in one-way communication with a receiving device. For example, the computer system 300 may only transmit messages or notifications to the receiving device and likewise the receiving device may only receive messages or notifications from the computer system 300. In other embodiments, the computer system 300 and the receiving device may engage in PTT communication. In such embodiments, the computer system 300 may operate in a transmission mode or a reception mode. When in transmission mode, the computer system 300 may transmit messages or notifications to the receiving device. When in reception mode, the computer system 300 may receive messages or notifications from the receiving device.

In some embodiments, the at least one network interface 342 may also allow the computer system 300 to receive or collect data from one or more BLE gateways that receive signals from BLE beacons or other BLE signal emitting devices. In such embodiments, the processor 310 may use the data from the BLE gateways to determine distances, proximities, or locations of receiving devices or associated actors or operators relative to a detected alert condition or health risk event.

In some embodiments, the at last one network interface 342 may also allow the computer system 300 to receive or collect RFID data from RFID readers that receive RFID signals from RFID tags or other RFID signal emitting devices. In such embodiments, the processor 310 may use the data from the RFID readers to determine distances, proximities, or locations of receiving devices or associated actors or operators relative to a detected alert condition o health risk event.

The at least one radio gateway 344 facilitates wired or wireless communication over a variety of communication networks or radio communication networks. For example, the computer system 300 may be connected to multiple receiving devices over multiple radio communication networks. For example, the computer system 300 may be connected to a first receiving device associated with or held by a first cook in a kitchen and a second receiving device associated with or held by a second cook in the kitchen. Further, the computer system 300 may be connected to the first receiving device over a first network and connected to the second receiving device over a second network. The computer system 300 may transmit and receive messages specific to the first cook over the first network. The computer system 300 may likewise transmit and receive messages specific to the second cook over the second network. Additionally or alternatively, the first and second receiving devices may also be connected to the computer system 300 via a third or shared network. The computer system 300 may transmit messages directed at both the first and second cooks over the third or shared network.

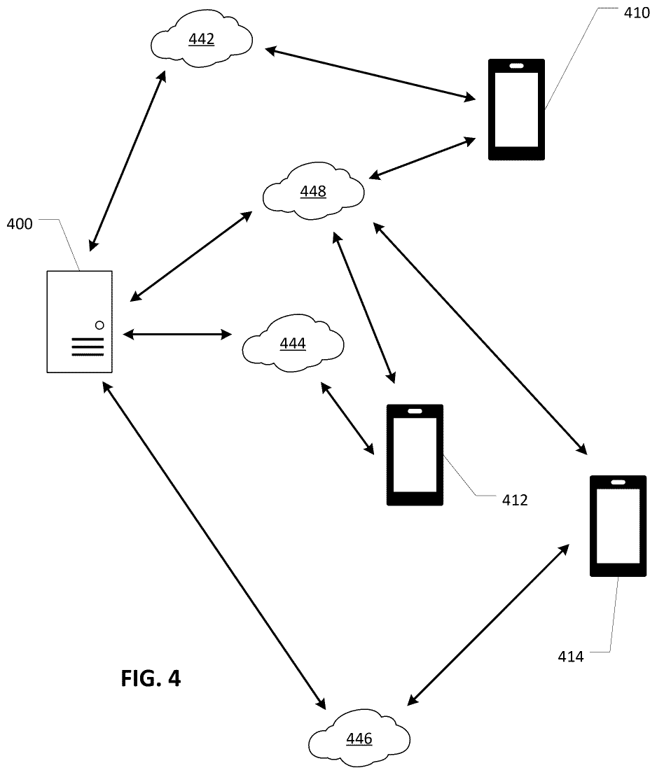

Reference is now made to FIG. 4 which shows a computer system 400 in communication with receiving devices 410, 412, and 414 over different communication networks or radio communication networks. Specifically, FIG. 4 shows a first communication network 442 connecting the computer system 400 to a first receiving device 410, a second communication network 444 connecting the computer system 400 to a second receiving device 412, a third communication network 446 connecting the computer system 400 to a receiving device 414, and a fourth communication network 448 connecting the computer system 400 to all of the receiving devices 410, 412, and 414. The computer system 400 may be exemplary of the computer system 100 or 300 (see FIGS. 1 and 3). The receiving devices 410, 412, and 414 may be exemplary of the receiving devices 110, 112, 114, or 200 (see FIGS. 1 and 2). The communication networks 442, 444, 446, and 448 may be exemplary of the at least one communication networks 140 (see FIG. 1).

The separate communication networks or radio communication networks allows the computer system 400 to send messages to any combination of the receiving devices 410, 412, and 414. In an example scenario, the first receiving device 410 may be held by a first cook in a monitored kitchen, the second receiving device 412 may be held by a second cook in the monitored kitchen, and the third receiving device 414 may be held by a third cook in the monitored kitchen. In particular, the third cook may be a supervisor of the first and second cook. In this example scenario, the computer system 400 may detect non-compliance with or breach of a health or hygiene standard, guideline, or protocol. For example, the first cook may be handling an unsanitary knife. Upon detecting the non-compliance or breach, the computer system 400 may first send a message to the first cook via the first communication network 442. The message may notify the first cook to clean or discard the unsanitary knife. In the event that the first cook fails to take action to rectify the instance of non-compliance or beach (i.e. does not initiate cleaning or discarding the knife) within a timeframe, such as ten seconds, the computer system 400 may then send a message over one of the other networks. For example, the computer system 400 may detect that the second cook is the next closest actor to the instance of non-compliance, after the first cook, and then send a message pertaining to the unsanitary knife to the second cook over the second communication network 444. Additionally or alternatively, the computer system 400 may send a message pertaining to the unsanitary knife to the third cook (or supervisor) over the third communication network 446. Additionally or alternatively, in the case of an emergency, for example, the computer system 400 may use the fourth communication network 448 to simultaneously send a message to the first, second, and third cooks.

While FIG. 4 depicts four communication networks, namely, the first communication network 442, the second communication network 444, the third communication network 446, and the fourth communication network 448, other embodiment may employ more or less communication networks or radio communication networks. For example, in some embodiments, there may be no shared communication network connecting all of the receiving devices. Additionally or alternatively, some embodiments may employ specialized communication networks for connecting a subset of the receiving devices to the computer system 400. For example, in the example scenario discussed previously, the first receiving device 410 (first cook) and the second receiving device 412 (second cook) may be connected to the computer system 400 over a shared fifth radio communication network that the third receiving device 414 (third cook and supervisor) is not connected to.

While the example scenario discussed above is a monitored kitchen, other embodiments (or the same) may be used in other example scenarios. For example, in a monitored operation room in a hospital or healthcare facility, the surgeon, anesthetist, and each surgery nurse may each have their own receiving device that is connected to the computer system 400 over separate and shared radio communication networks. In another example, in a childcare facility, different childcare workers may have their own receiving device that is connected to the computer system 400 over different and shared radio communication networks.

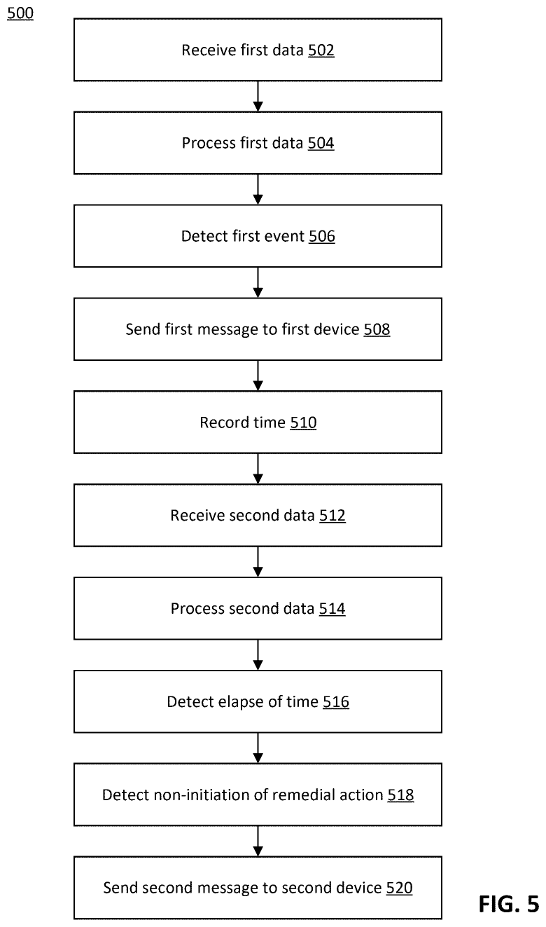

Reference is now made to FIG. 5 which shows, in flowchart form, a method 500 for generating and sending messages or notifications to receiving devices or operator devices in response to detecting an alert condition or health risk event in a monitored environment such as a kitchen, healthcare facility, childcare facility, or laboratory. The method 500 may be performed by a computer system that supports a surveillance or monitoring system such as the computer system 100, the computer system 300, or the computer system 400 (see FIGS. 1, 3, and 4). The computer system may be connected to a communication network or radio communication network and comprise a radio gateway and a processor coupled to the radio gateway. In particular, the computer system may have a memory storing computer executable instructions for the processor to execute operations of the method 500.

The method 500 may begin with an operation 502. At the operation 502, the processor may receive first data from one or more sensors deployed in the monitored environment. The one or more sensors may include, without limitation cameras, image capturing devices, video capturing devices, audio recorders, heat sensors, temperature sensors, moisture sensors, pressure sensors, smoke sensors, air quality sensors, chemical sensors, light sensors, touch sensors, motion sensors, BLE gateways, RFID readers, and wearable sensors. The first data received from the one or more sensors may include without limitation image data, video data, temperature data, moisture data, pressure data, air quality data, chemical data, light data, and BLE data.

Following the operation 502, flow control may proceed to an operation 504. At the operation 504, the processor may process the first data. Processing the first data may include without limitation using computer vision, video analytics, machine learning, artificial intelligence, or generative artificial intelligence to detect an alert condition, health risk event, or physical threat. For example, the first data may include image data captured by an image capturing device and the processor may use computer vision to process the image data. Additionally or alternatively, the first data may include video data captured by a video capturing device and the processor may use computer vision to analyze the video data. Examples of an alert condition or health risk event include without limitation a contaminated knife in a kitchen, improper handling of raw meat in kitchen, unsanitary surgical tools in an operation room, a toxic substance in an area for taking care of children, or improperly disposed toxic or radioactive materials in a laboratory.

Following the operation 504, flow control may proceed to an operation 506. At the operation 506, the processor may detect, from processing the first data, a first event. The first event may relate to at least one or more alert conditions, health risk events, or physical threats such as non-compliance with or breach of a health or safety standard, guideline, or protocol. Non-compliance with or breach of a health or safety standard, guidelines, or protocol may include, without limitation, poor hygienic practice, improper handling of raw meat, an unhygienic workspace, and improper handling of hazardous materials. Further, the first event may be associated with a first action. The first action may be considered a remedial or corrective action or measure for the first event. For example, if the first event is that a cook is using a contaminated knife, the first action may be to clean and sanitize the knife or discard the knife and use another knife to prepare a meal. In another example, if the first event is unsanitary surgical tools in an operation room, the first action may be to have prepared a new set of sanitized surgical tools prior to commencement of a surgery. In another example, if the first event is improper disposal of a radioactive material in a laboratory, the first action may be the proper disposal of the same. In another example, if the first event is a toxic substance in an area with many children, the first action may be removal of the toxic substance, a cleaning of the area, and washing hands. In some embodiments, the processor may determine the first action using artificial intelligence, machine learning, or generative artificial intelligence. For example, the processor may pass at least a portion of the first data to a generative artificial intelligence model, machine learning model, or artificial intelligence model. Further, in some embodiments, the processor may, prior to processing the first data in the operation 504, train an artificial intelligence model, such as a generative artificial intelligence model and/or a machine learning model, to detect at least one type of alert condition, health risk event, or physical threat. In some embodiments, training data for training the generative artificial intelligence model and/or machine learning model may include paired data wherein at least one of the pairs comprises an image paired with a textual description of a corresponding alert condition, health risk event, or physical threat. In other embodiments, the processor may determine the first action based on predefined rules. Such predefined rules may be stored in a database such as the database 130 (see FIG. 1).

While FIG. 5 depicts the operations 502, 504, and 506 as separate operations, in practice, the processor may execute the operations 502, 504, and 506 simultaneously. That is, the processor may detect the first event, alert condition, or health risk event in real-time by processing the first data in real-time.

Following the operation 506, flow control may proceed to an operation 508. At the operation 508, the processor may send, in response to detecting the first event, a first message to a first device associated with a first actor or operator. The first actor or operator may, as determined by the processor, be a person responsible for the first event. For example, if the first event is use of a contaminated kitchen knife, the first actor or operator may be the cook using the contaminated kitchen knife. In another example, if the first event is unsanitary surgical tools, the first actor or operator may be the nurse responsible for preparing the surgical tools. Additionally or alternatively, the first actor or operator may be, as determined by the processor, a person most suited to handle, rectify, or remedy the first event. For example, if the first event is a toxic substance in an area with children in a childcare facility, the first actor or operator may be the childcare worker most proximal to the toxic substance. In another example, if the first event is improperly disposed radioactive material in a laboratory, the first actor or operator may the laboratory technician closest to the improperly disposed radioactive material. The first device may be a receiving device or operator device such as the receiving devices 110, 112, 114, 200, 410, 412, or 414 (see FIGS. 1, 2, and 4).

In some embodiments, the processor may send the first message to the first device over a wireless communication network such as a PTT network, a cellular network, or a Wi-Fi network.

In some embodiments, the processor may determine the first actor (first device) to send the message to using artificial intelligence, machine learning, video analytics, or computer vision. For example, in the case of a contaminated kitchen knife, the processor may use computer vision or facial recognition software to identify the cook using the contaminated kitchen knife. The processor may then match the cook to the first device. In some embodiments, an association between the first device and the first actor may be recorded in a database. For example, the cook may have been assigned the first device. Additionally or alternatively, the cook may have registered use or assignment of the first device at the beginning of or during their shift. In other embodiments, the processor may determine an association between the first device and the first actor via proximity detecting technology. For example, the first device and a uniform of the cook may emit BLE signals, thereby allowing the processor to match the first device and the cook based on proximity of the BLE signal transmissions. Other techniques for proximity detection include Wi-Fi triangulation, and techniques that use radio frequency identification (RFID) such as real-time location system (RTLS) and RFID proximity tracking.

In some embodiments, the first message may describe the first event. For example, in the case of a contaminated kitchen knife, the first message may be “You are using a contaminated kitchen knife.” In another example, in the case of improperly disposed radioactive material in a laboratory, the first message may be “Improperly disposed Plutonium-245 found at Table 4 of Laboratory C.” In some embodiments, the first message may further include directions to handle, remedy, or rectify the first event. That is, the first message may include direction to apply a corrective measure to the first event, alert condition, health risk event, or physical threat. For example, in the case of the contaminated kitchen knife, the first message may further include “Please send the knife to cleaning and use a different knife.”

In some embodiment, prior to sending the message to the first device, the processor may generate the first message using generative artificial intelligence. For example, an artificial intelligence model or generative artificial intelligence model may generate the first message during the processing or detecting stages of the first event (the operation 504 or 506). That is, the processor may generate the first message by passing at least a portion of the first data to a generative artificial intelligence model.

In some embodiments, prior to sending the message to the first device, the processor may generate the first message based on a predefined template for generating messages in response to detected alert conditions or health risk events. A predefined template for generating messages may be stored and loaded into the memory from an internal storage of the computer system or an external storage. The database 130 may be exemplary of an external storage (see FIG. 1). In some embodiments, in response to detecting the first event, the processor may select a first template from one or more templates stored in a storage medium. The processor may select the first template based on an association with the first event or a type of the first event. For example, in the event that the monitored environment is a kitchen, and the first event corresponds to a contaminated knife, the processor may select a template (first template) for contaminated knives of contaminated utensils. The processor may generate the first message based on the selected first template.

Following the operation 508, flow control may proceed to an operation 510. At the operation 510, the processor may record a first time in association with the first event. The first time may be the time that the processor detected the first event. The processor may record this first time to a storage medium such as an internal storage of the computer system an external storage.

Following the operation 510, flow control may proceed to an operation 512. At the operation 512, the processor receives second data from at least one of the one or more sensors deployed in, on, or around the monitored environment. Following the operation 512, flow control may proceed to an operation 514. At the operation 514, the processor may process the second data. Similar to the operation 504, the processor may process the second data using artificial intelligence, machine learning, generative artificial intelligence, computer vision, or video analytics. Further, while FIG. 5 depicts the operations 512 and 514 as separate, in some embodiments, the processor may execute the operations 512 and 514 simultaneously. In some embodiments, the processor may receive and process a stream of data from the one or more sensors in real time. The first data and the second data may be considered part of this stream of data.

Following the operation 514, flow control may proceed to an operation 516. At the operation 514 the processor may detect an elapse of time. The elapse of time may be an elapse of a predefined or predetermined amount of time following detection of the first event in the operation 506 and as recorded in the operation 510. For example, the elapse of time may be, without limitation, 10 seconds, 15 seconds, 30 seconds, a minute, 5 minutes, or 10 minutes.

Following the operation 516, flow control may proceed to an operation 518. At the operation 518, the processor may detect, from processing the second data, non-initiation of the first action or remedial action by the actor or holder of the first device. That is, the processor may determine that the first actor has not initiated performance of the first action within a time frame, the time frame being defined by the first time and a predefined or predetermined amount of time subsequent the first time. For example, in the event that the monitored environment is a kitchen, the first event is a contaminated knife, and the processor sent a first cook (first device) a message indicating that the knife is contaminated and to obtain a new knife, during the operation 518, the processor may determine that the first cook has not attempted to obtain a new uncontaminated knife within 15 seconds of being notified. In another example, in the event that the monitored environment is a laboratory, the first event is improper disposal of radioactive material, and the processor sent a first laboratory technician (first device) a message directing the first laboratory technician to correctly dispose the radioactive material, during the operation 518, the processor may determine that the first laboratory technician has not attempted to correctly dispose the radioactive material as instructed within 5 minutes of being notified.

While FIG. 5 depicts the operations 512, 514, 516, and 518 as separate, in some embodiments or situations, the processor may execute any combination of the operations 512, 514, 516, and 518 simultaneously.

Following the operation 518, flow control may proceed to an operation 520. At the operation 520, the processor may send, in response to determining that the actor has not initiated performance of the first action in the operation 518, a second message to a second device. The second device may be a receiving device or operator device such as the receiving devices 110, 112, 114, 200, 410, 412, or 414 (see FIGS. 1, 2, and 4). The second device may be associated with a second actor. The second actor may be, for example, another actor or operator in the monitoring environment. In some embodiments, the second actor may be a person satisfying a proximity condition. For example, the second actor may be staff, personnel, or an employee that is closest to the first actor or within a radius of the first actor. Additionally or alternatively, the second actor may be staff, personnel, or an employee that is closest to the first actor. Additionally or alternatively, the second actor may be staff, personnel, or an employee that is within a radius of a location associated with the first event. In other embodiments, the first actor and the second actor, and thereby the first device and the second device, may be associated with a first status and a second status respectively. Further, the second status may be superior or considered superior to the first status. For example, the second device may be associated with a supervisor of the first device. In another example, in the event that the monitored environment is an operation room, the second device may be associated with a surgeon and the first device may be associated with a nurse. In another example, in the event that the monitored environment is a kitchen, the second device may be associated with a head chef and the first device may be associated with a line cook. In these embodiments where the first device and the second device are associated with a first status and a second status respectively, during execution of the operation 520, the processor may determine to send the second message to the second device based on the second device having a status superior to the first status.

In some embodiments, similar to the operation 508, the processor may generate the second message using artificial intelligence, generative artificial intelligence, computer vision, video analytics, or templates. In other embodiments, the first message and the second message may be identical or similar.

In some embodiments, the processor may send the second message to the second device over a wireless communication network such as a PTT network, a cellular network, or a Wi-Fi network.

While FIG. 5 shows one thread of a process executed by the processor with respect to a first event or single alert condition, health risk event, or physical threat, the processor may simultaneously execute similar threads or operations for other or second events, alert conditions, health risk events, or physical threats. For example, subsequent to the operation 508 and during the operations 512 and 514, the processor may continue to monitor and process data from the one or more sensors for additional alert conditions, health risk events, or physical threats. That is, the processor may be simultaneously execute operations similar to the operations 502 and 504 for another or a second event as the processor executes the operations 512 and 514 for the first event.

In some embodiments, during or subsequent to the execution of the method 500, the processor may store or record data to a storage medium such as the database 130 (see FIG. 1). For example, the processor may record, in association with the actor (such as in a profile or data record relating to the actor), performance data wherein the performance data includes at least one of: the detecting of the first event, the first message, the determining that the actor has not initiated performance of the first action within the time frame, and the second message. At a later time, the processor may retrieve, from the storage medium, the performance data associated with the actor. The processor may determine, based on the performance data, a score for the actor. The score more be a measure of the actor's performance or ability to comply with applicable standards, guidelines, and protocols. In another example, the processor may retrieve the performance data to, for example, generate a report. The report may, for example, relate to an evaluation of an employee or staff member. The report may also include the score of the actor (employee or staff member). In another example, the report may relate to enhancing safety in a workplace.

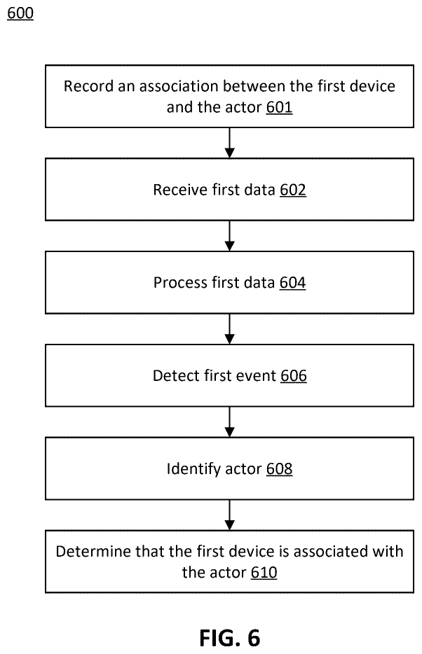

Reference is now made to FIG. 6 which shows, in flowchart form, a method 600 for determining, in a monitored environment, that a receiving device or operator device is associated with an actor. The method 600 may be performed by a computer system that supports a surveillance or monitoring system such as the computer system 100, the computer system 300, or the computer system 400 (see FIGS. 1, 3, and 4). The computer system may be connected to a communication network or radio communication network and comprise a radio gateway and a processor coupled to the radio gateway. In particular, the computer system may have a memory storing compute executable instructions for the processor to execute operations of the method 600.

The method 600 begins with an operation 601. At the operation 601, the processor may record, in a storage medium or database such as the database 130, an association between a first device, such as one of the receiving devices 110, 112, 114, and 200, and an actor, operator, staff, personnel, employee, or the like (see FIGS. 1 and 5). For example, a cook in a restaurant kitchen may register their use, ownership, access, or custodianship of a receiving device, such as an ear piece, at the beginning of their shift. Additionally or alternatively, the processor may have recorded the association between the cook and the receiving device when the cook began their employment in the restaurant.

In some embodiments, the actor may register an association with the first device via input to a computing device such as a smartphone or personal computer. For example, the computing device may have installed an application maintained by the computer system 100. The actor may input, via the application, an employee identifier and a device identifier wherein the device identifier identifies the first device. The computer system 100 may receive the employee identifier and device identifier and, responsive thereto, record an association between the actor and the first device (or employee identifier and device identifier).

In other embodiments, the actor may register an association with the first device via input to the first device. For example, the actor may log into the first device by providing authentication credentials such as a username and password or biometric data such as a fingerprint. The first device may then send or communicate the authentication credentials to the processor via, for example, the at least one network 140 (see FIG. 1). The processor may then identify an employee identifier from the authentication credentials and a device or network identifier from metadata associated with the communication from the first device. The processor may then record an association between the actor and the first device (or employee identifier and device or network identifier).

In some embodiments, the first device may be associated with a network, communication network, or radio communication network. In these embodiments, the processor may record an association between the network and the actor.

Following the operation 601, flow control may proceed to an operation 602. At the operation 602, the processor may receive first data from one or more sensors deployed in, on, or around the monitored environment. That is, the processor may, prior to receiving the first data from the one or more sensors, record, in the storage medium or database, an association between the first device and the actor. The operation 602 may be performed in manners similar to that of the operation 502 of the method 500 as described herein (see FIG. 5).

Following the operation 602, flow control may proceed to an operation 604. At the operation 604, the processor may process the first data. The operation 604 may be performed in manners similar to that of the operation 504 of the method 500 as described herein (FIG. 5).

Following the operation 604, flow control may proceed to an operation 606. At the operation 606, the processor may detect a first event, alert condition, or health risk event. The operation 606 may be performed in manners similar to that of the operation 606 of the method 600 as described herein (FIG. 6).

Following the operation 606, flow control may proceed to the operation 608. At the operation 608, the processor may identify the actor by processing the first data. In particular, the processor may identify that the actor is associated with or responsible for the first event. For example, the processor may identify that a particular cook in a kitchen has inadequately washed their hands. In another example, the processor may identify a childcare worker who is closest to a safety hazard in a childcare facility.

In some embodiments, the processor may identify the actor using at least a facial recognition application. That is, the processor may process image data or video data received from the one or more sensors to identify the actor. Further, in some embodiments, the facial recognition application may output an identifier such as an employee identifier or employee ID that identifies the actor.

It should be appreciated that while FIG. 6 depicts the operations 606 and 608 as separate steps, in some embodiments, the operations 606 and 608 may be performed simultaneously. For example, the processor may simultaneously, or near-simultaneously, detect the first event and identify the actor.

Following the operation 608, flow control may proceed to an operation 610. At the operation 610, the processor may determine that the first device is associated with the actor. For example, the processor may perform a lookup operation in the storage medium or database to identify the first device based on the actor or identifier that identifies the actor. In some embodiments, the processor may identify the first device by a device identifier that is stored, in the storage medium or database, in association with the actor or identifier for the actor. In another embodiment, a network or network identifier may be stored in association with the actor or identifier for the actor. In such embodiments, identifying a network and sending a message via this identified network may cause the processor to send a message to the first device.

It should be appreciated that the method 500 and the method 600 may be performed together or simultaneously and, in some instances, overlap (e.g. the operations 502, 504, 506, 602, 604, and 606). Further in some embodiments, the operations 608 and 610 may be performed or executed prior to the operation 508. That is, prior to sending the first message to the first device (the operation 608), the processor may identify the actor (the operation 608) and determine that the first device is associated with the actor (the operation 610).

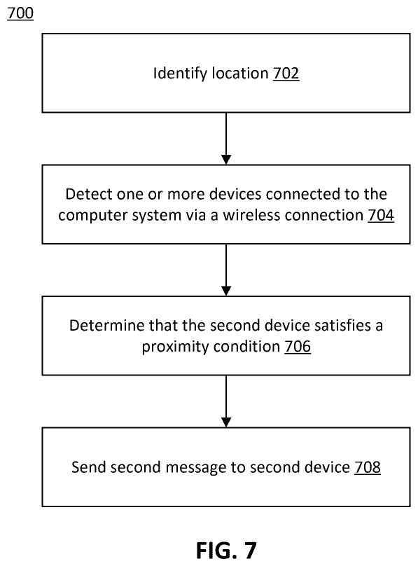

Reference is now made to FIG. 7 which shows, in flowchart form, a method 700 for sending a second message to a second operator device or second receiving device in response to detecting a non-initiation of remedial action with respect to a detected alert condition or health risk event in a monitored environment such as a kitchen, healthcare facility, childcare facility, or laboratory. In some embodiments or situations, the method 700 may be considered an implementation of the operation 520 from the method 500 (see FIG. 5). That is, the method 700 may execute subsequent to the execution of the operation 518 from the method 500 (see FIG. 5). The method 700 may be performed by a computer system that supports a surveillance or monitoring system such as the computer system 100, the computer system 300, or the computer system 400 (see FIGS. 1, 3, and 4). The computer system may be connected to a communication network or radio communication network and comprise a radio gateway and a processor coupled to the radio gateway. In particular, the computer system may have a memory storing computer executable instructions for the processor to execute operations of the method 700.

The method 700 may begin with an operation 702. At the operation 702, the processor may identify a location associated with a first event. The first event may be an alert condition, health risk event, or physical threat detected by the processor or computer system. In some embodiments, the processor may identify the location using computer vision, video analytics, or artificial intelligence techniques. In other embodiments, the processor may identify the location using a wireless connection with a first device associated with the first event. For example, the first device may be a receiving device of an actor, employee, or staff member related to the first event. The first device may have a BLE beacon and the processor may, via a BLE gateway, determine the location of the first device from BLE signals emitted therefrom. Additionally or alternatively, the processor may use Wi-Fi triangulation to determine the location of the first device. For example, one or more routers may be deployed in or around the monitored environment. Each router may approximate the distance from itself to the first device based on Wi-Fi signals emitted to or from the first device. The processor may then use this information or data to determine the location of the first device. Additionally or alternatively, the processor may use an RFID tracking system to determine the location of the first device. For example, the first device may have an active RFID tag emitting an RFID signal and a plurality of RFID readers may be positioned throughout the monitored environment. The processor may use a triangulation technique to determine the location of the first device based on at least one of the plurality of RFID readers detecting the signal emitted by the RFID tag. In another example, short-range RFID readers may be deployed around the monitored environment, thereby allowing the processor to determine the location of the first device based on proximity to a particular short-range RFID reader.

Following the operation 702, flow control may proceed to an operation 704. At the operation 704, the processor may detect, via at least one wireless connection, one or more devices connected to the computer system. These one or more devices may be receiving devices or operator devices. Further, these one or more devices may not include the first device. In some embodiments, the at least one wireless connection used to detect the one or more devices may be BLE connections or transmissions between the one or more devices and at least one BLE gateway. That is, the processor may use BLE techniques using at least one BLE beacon and/or at least one BLE gateway to detect the one or more devices. In some embodiments, the at least one wireless connection used to detect the one or more devices may be Wi-Fi connections or transmissions between the one or more devices and routers deployed in or around the monitored environment. That is, the processor may use Wi-Fi triangulation techniques to detect the one or more devices. In some embodiments, the processor may use RFID tags, RFID readers, and/or RFID systems to detect the one or more devices.

Following the operation 704, flow control may proceed to an operation 706. At the operation 706, the processor may determine that, among the detected one or more devices, a second device satisfies a proximity condition associated with the first event. In some embodiments, the proximity condition may be that the second device is located or situated within a predefined radius of the location associated with the first event. For example, the proximity condition may be that the second device is located or situated within 10 meters of the first event. In other embodiments, the proximity condition may be that the second device is, excluding the first device, the closest receiving device to the location associated with the first event. In some embodiments, the processor may use BLE techniques, such as using at least one BLE beacon and/or at least one BLE gateway, Wi-Fi triangulation techniques, such as using at least one router deployed in or around the monitored environment, and/or RFID techniques such as using at least one RFID reader deployed in or around the monitored environment, to determine that the second device satisfies the proximity condition.

Following the operation 706, flow control may proceed to an operation 708. At the operation 708, the processor may send, in response to determining that the second device satisfies the proximity condition, a second message to the second device. In some embodiments, the second message may be the second message as described with respect to the method 500 (see FIG. 5).

Although the present disclosure describes methods and processes with operations (e.g., steps) in a certain order, one or more operations of the methods and processes may be omitted or altered as appropriate. One or more operations may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer-implemented method, the method comprising:
receiving, at a computer system, first data from one or more sensors;
processing the first data;
detecting, from processing the first data, a first event, the first event being associated with a first action, the first action being a remedial action for the first event;
sending, in response to detecting the first event, a first message to a first device, the first device being associated with an actor;
recording a first time in association with the first event;
receiving, subsequent to sending the first message to the first device, second data from at least one of the one or more sensors;
processing the second data;
determining, from processing the second data, that the actor has not initiated performance of the first action within a time frame, the time frame being defined by the first time and a predetermined amount of time following the first time; and
sending, in response to determining that the actor has not initiated performance of the first action within the time frame, a second message to a second device.

2. The computer-implemented method of claim 1 wherein the method further comprises:
prior to receiving the first data from the one or more sensors, recording, in a storage medium, an association between the first device and the actor; and
prior to sending the first message to the first device:
identifying the actor by processing the first data using at least a facial recognition application; and
determining that the first device is associated with the actor by performing a lookup operation in the storage medium.

3. The computer-implemented method of claim 1 wherein:
the one or more sensors include an image capturing device;
the first data includes image data captured by the image capturing device; and
processing the first data further comprises using computer vision to process the image data.

4. The computer-implemented method of claim 1 wherein sending the second message to the second device further comprises:
identifying a location associated with the first event;
detecting, via at least one wireless connection, one or more devices connected to the computer system, the one or more devices including the second device and not including the first device;
determining that, among the one or more devices, the second device satisfies a proximity condition associated with the first event; and
sending, in response to determining that the second device satisfies the proximity condition, the second message to the second device.

5. The computer-implemented method of claim 4 wherein determining that the second device satisfies the proximity condition comprises using at least one Bluetooth low energy beacon.

6. The computer-implemented method of claim 4 wherein determining that the second device satisfies the proximity condition comprises using a Wi-Fi triangulation technique.

7. The computer-implemented method of claim 1 wherein:
the first device is associated with a first status;
the second device is associated with a second status, the second status being superior to the first status; and
sending the second message to the second device further comprises determining to send the second message to the second device based on the second status being superior to the first status.

8. The computer-implemented method of claim 1 wherein:
the first event relates to a physical threat; and
the first action is applying a corrective measure to the physical threat.

9. The computer-implemented method of claim 1 wherein the method further comprises, prior to sending the first message:
selecting, in response to detecting the first event, a first template from one or more templates, the first template being associated with the first event; and
generating the first message based on the first template.

10. The computer-implemented method of claim 1 wherein the method further comprises generating the first message by passing at least a portion of the first data to a generative artificial intelligence model.

11. The computer-implemented method of claim 1 wherein detecting the first event further comprises passing at least a portion of the first data to a generative artificial intelligence model.

12. The computer-implemented method of claim 1 wherein:
the first event relates to at least one of one or more alert conditions, the alert conditions including: poor hygienic practice, improper handling of raw meat, an unhygienic workspace, and improper handling of hazardous materials;
the method further comprises training, prior to processing the first data, an artificial intelligence model to detect the at least one of the one or more alert conditions; and
processing the first data comprises using the artificial intelligence model to detect the first event.

13. The computer-implemented method of claim 1 wherein sending the first message further comprises transmitting the first message to the first device via a push-to-talk network.

14. The computer-implemented method of claim 1 wherein the method further comprises:
recording, in a storage medium and in association with the actor, performance data, the performance data including at least one of:
the detecting of the first event;
the first message;
the determining that the actor has not initiated performance of the first action within the time frame; and
the second message;
retrieving, from the storage medium, the performance data; and
determining, based on the performance data, a score for the actor.

15. A computer system comprising:
a processor; and
a memory coupled to the processor, the memory storing instructions that, when executed by the processor, cause the processor to:
receive first data from one or more sensors;
process the first data;
detect, from processing the first data, a first event, the first event being associated with a first action, the first action being a remedial action for the first event;
send, in response to detecting the first event, a first message to a first device, the first device being associated with an actor;
record a first time in association with the first event;
receive, subsequent to sending the first message to the first device, second data from at least one of the one or more sensors;
process the second data;
determine, from processing the second data, that the actor has not initiated performance of the first action within a time frame, the time frame being defined by the first time and a predetermined amount of time following the first time; and
send, in response to determining that the actor has not initiated performance of the first action within the time frame, a second message to a second device.

16. The computer system of claim 15 wherein the instructions further configure the processor to:
prior to receiving the first data from the one or more sensors, record, in a storage medium, an association between the first device and the actor; and
prior to sending the first message to the first device:
identify the actor by processing the first data using at least a facial recognition application; and
determine that the fist device is associated with the actor by performing a lookup operation in the storage medium.

17. The computer system of claim 15 wherein sending the second message to the second device further comprises:
identifying a location associated with the first event;
detecting, via at least one wireless connection, one or more devices connected to the computer system, the one or more devices including the second device and not including the first device;
determining that, among the one or more devices, the second device satisfies a proximity condition associated with the first event; and
sending, in response to determining that the second device satisfies the proximity condition, the second message to the second device.

18. The computer system of claim 15 wherein the instructions further configure the processor to generate the first message by passing at least a portion of the first data to a generative artificial intelligence model.

19. The computer system of claim 15 wherein detecting the first event further comprises passing at least a portion of the first data to a generative artificial intelligence model.

20. The computer system of claim 15 wherein:
the first event relates to at least one of one or more alert conditions, the alert conditions including: poor hygienic practice, improper handling of raw meat, an unhygienic workspace, and improper handling of hazardous materials;
the instructions further configure the processor to train, prior to processing the first data, an artificial intelligence model to detect the at least one of the one or more alert conditions; and
processing the first data comprises using the artificial intelligence model to detect the first event.
